(19) United States
(12) Patent Application Publication
(10) Pub. No.: US 2018/0098047 A1
(43) Pub. Date: Apr. 5, 2018

(54) IMAGING SYSTEM, IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: Kina ITAKURA, Yokohama-shi (JP); Tatsuro KOIZUMI, Niiza-shi (JP); Kaori TAYA, Yokohama-shi (JP); Shugo HIGUCHI, Inagi-shi (JP)

(21) Appl. No.: 15/705,626

(22) Filed: Sep. 15, 2017

(30) Foreign Application Priority Data
Sep. 30, 2016 (JP) 2016-194777

(51) Int. Cl. H04N 13/00; G06T 7/90; G06T 7/62; H04N 13/02

(52) U.S. Cl. CPC H04N 13/0011; G06T 7/90; G06T 7/62; G06T 15/04; H04N 13/0278; G06T 2207/10024; H04N 13/0242

(57) ABSTRACT

There is provided with an imaging system. The imaging system has a plurality of image capturing apparatuses. The plurality of image capturing apparatuses are configured to obtain captured images to generate a free-viewpoint image. The plurality of image capturing apparatuses include a first group of one or more image capturing apparatuses facing a first gaze point and a second group of one or more image capturing apparatuses facing a second gaze point different from the first gaze point.

### BACKGROUND OF THE INVENTION

### Field of the Invention

The present invention relates to an imaging system, an image processing apparatus, an image processing method, and a storage medium.

### Description of the Related Art

There is known a technique of reconstructing, from images obtained by capturing an object using a plurality of image capturing apparatuses, an image which is obtained when an object is observed from an arbitrary virtual viewpoint. For example, Japanese Patent Laid-Open No. 2010-020487 discloses the following method. First, a three-dimensional model of an object is created by using captured images of the object captured by a plurality of cameras. Next, a texture image of each position on the three-dimensional model is generated by blending texture images included in the plurality of captured images. Finally, by texture mapping each blended texture image onto the three-dimensional model, an image can be reconstructed from a virtual viewpoint in which no camera is arranged.

Japanese Patent Laid-Open No. 2010-020487 shows an example in which forty cameras are placed facing an object so as to surround the object. On the other hand, Japanese Patent Laid-Open No. 2010-039501 proposes a method of further using a vertex camera placed above and facing an object to improve the accuracy of a reconstruction image.

### SUMMARY OF THE INVENTION

According to an embodiment of the present invention, an imaging system comprises a plurality of image capturing apparatuses, wherein the plurality of image capturing apparatuses are configured to obtain captured images to generate a free-viewpoint image, and wherein the plurality of image capturing apparatuses include a first group of one or more image capturing apparatuses facing a first gaze point and a second group of one or more image capturing apparatuses facing a second gaze point different from the first gaze point.

According to another embodiment of the present invention, an imaging system comprises a plurality of image capturing apparatuses, wherein each of the plurality of image capturing apparatuses are configured to obtain a captured image to generate a free-viewpoint image, and wherein the plurality of image capturing apparatuses include a first group of one or more image capturing apparatuses and a second group of one or more image capturing apparatuses having a wider field angle than the first group of image capturing apparatuses.

According to still another embodiment of the present invention, an image processing apparatus comprises: an obtaining unit configured to obtain a captured image obtained by each of a plurality of image capturing apparatuses by capturing an object; a setting unit configured to set a virtual viewpoint of a reconstruction image; an estimation unit configured to estimate a shape of the object by selecting, from the plurality of image capturing apparatuses, a group of selected image capturing apparatuses to be used for estimating the shape of the object and using each captured image obtained by the group of selected image capturing apparatuses; and a generation unit configured to estimate a color of the object by using both the captured image obtained by the group of selected image capturing apparatuses and a captured image obtained by a group of unselected image capturing apparatuses which was not selected as the group of selected image capturing apparatuses and generate the reconstruction image from the virtual viewpoint based on the estimated shape and color of the object.

According to yet another embodiment of the present invention, an image processing method comprises: obtaining a captured image obtained by each of a plurality of image capturing apparatuses by capturing an object; setting a virtual viewpoint of a reconstruction image; estimating a shape of the object by selecting, from the plurality of image capturing apparatuses, a group of selected image capturing apparatuses to be used for estimating the shape of the object and using each captured image obtained by the group of selected image capturing apparatuses; estimating a color of the object by using both the captured image obtained by the group of selected image capturing apparatuses and a captured image obtained by a group of unselected image capturing apparatuses which was not selected as the group of selected image capturing apparatuses; and generating the reconstruction image from the virtual viewpoint based on the estimated shape and color of the object.

According to still yet another embodiment of the present invention, a non-transitory computer-readable medium stores a program for causing a computer to: obtain a captured image obtained by each of a plurality of image capturing apparatuses by capturing an object; set a virtual viewpoint of a reconstruction image; estimate a shape of the object by selecting, from the plurality of image capturing apparatuses, a group of selected image capturing apparatuses to be used for estimating the shape of the object and using each captured image obtained by the group of selected image capturing apparatuses; estimate a color of the object by using both the captured image obtained by the group of selected image capturing apparatuses and a captured image obtained by a group of unselected image capturing apparatuses which was not selected as the group of selected image capturing apparatuses; and generate the reconstruction image from the virtual viewpoint based on the estimated shape and color of the object.

Further features of the present invention will become apparent from the following description of exemplary embodiments (with reference to the attached drawings).

### BRIEF DESCRIPTION OF THE DRAWINGS

FIG. 1 is a view showing an arrangement example of an imaging system according to an embodiment;

FIG. 2 is a view showing an arrangement example of an imaging system according to an embodiment;

FIG. 3 is a view showing an arrangement example of an imaging system according to an embodiment;

FIG. 4 is a view showing another arrangement example of the imaging system according to the embodiment;

FIG. 5 is a block diagram showing an example of the hardware arrangement of an image processing apparatus according to an embodiment;

FIG. 6 is a block diagram showing an example of the functional arrangement of the image processing apparatus according to the embodiment; and

FIG. 7 is a flowchart showing a processing example of an image processing method according to the embodiment.

### DESCRIPTION OF THE EMBODIMENTS

The methods disclosed in Japanese Patent Laid-Open Nos. 2010-020487 and 2010-039501, respectively, are suitable for generating a reconstruction image of an object present in a predetermined position. However, when applying these methods to a case in which objects are dispersed and moving in a wide space (for example, an athletic field) such as in the case of imaging of a sports activity, these methods disclosed in Japanese Patent Laid-Open Nos. 2010-020487 and 2010-039501 pose some problems. For example, if each camera is placed facing the center of the field in accordance with Japanese Patent Laid-Open No. 2010-039501, a high-quality reconstruction image can be generated for an object that is present in the center of the field. On the other hand, for an object that is present at the edge of the field, a reconstruction image may not be obtained or may be of a lower quality since the number of cameras capturing this object is limited.

Some embodiments of the present invention provide an imaging system that can obtain an image having a balanced image quality for each object present in various positions in a space when generating a reconstruction image from a virtual viewpoint.

The embodiments of the present invention will be described below based on the accompanying drawings. However, note that the scope of the present invention is not limited to the following embodiments. For example, in order to allow the generation of a reconstruction image of an object present in an arbitrary location in a space, cameras each having a short focal length (wide field angle) can be placed so as to surround the space. On the other hand, since the object on the captured image will become small due to the short focal length of each camera, the quality of the reconstruction image may be undesirably degraded.

In the following embodiments, each camera is placed in consideration of reducing a capturing-target area in which quality degradation occurs due to having few cameras to perform imaging of the object (to be referred to as “improvement of viewpoint flexibility” hereinafter). In addition, in the following embodiments, each camera is arranged in consideration of suppressing quality degradation (to be called “improvement of image quality” hereinafter) because the object image captured on the image is small.

### FIRST EMBODIMENT

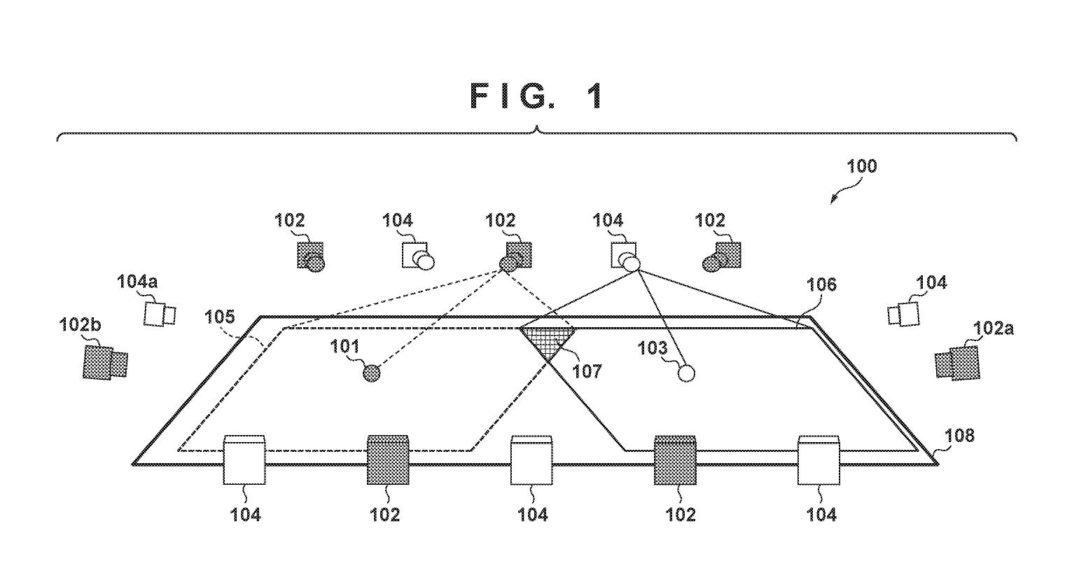

An imaging system 100 according to the first embodiment will be described with reference to FIG. 1. The imaging system 100 includes a plurality of image capturing apparatuses 102 and a plurality of image capturing apparatuses 104 and obtains, in order to generate a free-viewpoint image, captured images by using the plurality of image capturing apparatuses 102 and the plurality of image capturing apparatuses 104. A free-viewpoint image indicates a reconstruction image obtained from an arbitrarily set virtual viewpoint. The image capturing apparatuses 102 and 104 are arranged facing a space so as to surround the space in which an object is present. For example, the image capturing apparatuses 102 and 104 can be placed so as to surround a field 108 (for example, an athletic field).

The plurality of image capturing apparatuses 102 and the plurality of image capturing apparatuses 104 included in the imaging system 100 include the first group of image capturing apparatuses 102 including one or more image capturing apparatuses, and the second group of the image capturing apparatuses 104 including one or more image capturing apparatuses. The first group of image capturing apparatuses 102 is placed facing a first gaze point 101. Also, the second group of image capturing apparatuses 104 is placed facing a second gaze point 103 which is different from the first gaze point 101. A gaze point is an arbitrary point placed on a space. In this embodiment, an object is present on the field 108 and each gaze point is also placed on the field 108. More specifically, each gaze point is placed on an intersection of the optical axes of corresponding image capturing apparatuses and the field 108. However, the gaze point may also be set in midair.

In one embodiment, the first group of image capturing apparatuses 102 is placed facing the first gaze point 101 so as to be focused on the first gaze point 101, and the second group of image capturing apparatuses 104 is placed facing the second gaze point 103 so as to be focused on the second gaze point 103. However, if each image capturing apparatus has a deep depth of field, it need not be accurately focused on the gaze point.

The first group of image capturing apparatuses 102 is placed so that a first area 105 on the field is in the field of view of each apparatus. In other words, the first area 105 is a commonly viewed area of the first group of image capturing apparatuses 102. The second group of image capturing apparatuses 104 is also placed so that a second area 106 on the field is in the field of view of each apparatus. In other words, the second area 106 is a commonly viewed area of the second group of image capturing apparatuses 104. According to such an arrangement, the first group of image capturing apparatuses 102 can capture at least an object on the first area 105. Also, the second group of image capturing apparatuses 104 can capture at least an object on the second area 106.

The first group of image capturing apparatuses 102 and the second group of image capturing apparatuses 104 are placed so as to surround the field 108. Also, the first group of image capturing apparatuses 102 is placed to surround the first gaze point 101. For example, in FIG. 1, at least one image capturing apparatus 102a of the first group of image capturing apparatuses 102 is placed closer to the second area 106 than the first area 105. The image capturing apparatus 102a is also closer to the second gaze point 103 than the first gaze point 101. Such an arrangement allows the first group of image capturing apparatuses 102 to capture an object on the first area 105 from various directions. On the other hand, the second group of image capturing apparatuses 104 is placed to surround the second gaze point 103. For example, in FIG. 1, at least one image capturing apparatus 104a of the second group of image capturing apparatuses 104 is placed closer to the first area 105 than the second area 106. The image capturing apparatus 104a is also closer to the first gaze point 101 than the second gaze point 103. Such an arrangement allows the second group of image capturing apparatuses 104 to capture an object on the second area 106 from various directions.

In this embodiment, the first area 105 and the second area 106 cover almost the entire field 108. For example, the ratio in which the sum of the first area 105 and second area 106 occupies the field 108 is 80% or more in one embodiment, 90% or more in another embodiment, 95% or more in still another embodiment, and 100% in still another embodiment. This kind of an arrangement allows at least either the first group of image capturing apparatuses 102 or the second group of image capturing apparatuses 104 to capture an image from various directions for each object present in various positions in the field 108. As a result, a reconstruction image of each object present in various positions in the field 108 can be generated, and thus improve the viewpoint flexibility. In another embodiment, it is possible to further provide a group of image capturing apparatuses which is placed so that an additional area on the field 108 will be in the field of view of each apparatus. In this case, the imaging system can be arranged so that almost the entire field 108 will be covered by the commonly viewed areas of the respective groups of image capturing apparatus.

Additionally, in this embodiment, a common area 107 between the first area 105 and the second area 106 is small. The ratio occupied by the common area 107 in the sum of the first area 105 and the second area 106 is 30% or less, 20% or less in another embodiment, 10% or less in still another embodiment, and 5% or less in still another embodiment. Furthermore, in this embodiment, the barycenter of the first area 105 is not included in the second area 106. The barycenter of the second area 106 is also not included in the first area 105. By narrowing the first area 105 and the second area 106 in this manner, it is possible to narrow the field angles of the image capturing apparatuses 102 of the first group and the image capturing apparatuses 104 of the second group, and thus improve the image quality.

In one embodiment, the number of image capturing apparatuses to be included in the first group of image capturing apparatuses 102 can be determined in accordance with the size of the first area 105. That is, the number of image capturing apparatuses can be increased when the first area 105 is large. The same goes for the second area 106.

According to the conventional technique, the gaze point of each image capturing apparatus is set in the center of the field 108. Hence, an object which is present in a peripheral portion of the field 108 could be captured by only a few image capturing apparatuses, and a reconstruction image of this object could not be generated in some cases. On the other hand, according to this embodiment, an object can be captured by a predetermined number or more of image capturing apparatuses in a wider area of the field 108, and a reconstruction image of this object can be generated. That is, it is possible to improve the viewpoint flexibility. According to this embodiment, although the number of image capturing apparatuses capable of capturing an object present in the center of the field 108 may decrease in comparison with that in the conventional technique, it is still conceivable for a sufficient quality reconstruction image to be generated for this object. Therefore, it is possible to maintain image quality.

### SECOND EMBODIMENT

In the first embodiment, the plurality of image capturing apparatuses 102 and the plurality of image capturing apparatuses 104 were placed to face the first gaze point 101 and the second gaze point 103, respectively. The placement method of the image capturing apparatuses is not limited to this. For example, by placing a plurality of image capturing apparatuses so as to face various directions in a space, an object can be captured by a predetermined number or more of image capturing apparatuses in a wider area of the space, and thus the viewpoint flexibility can be improved. Additionally, according to this kind of an arrangement, the field angle of each image capturing apparatus need not be widened so as to cover the entire space, and thus it is possible to improve image quality. In this manner, by using a first group of image capturing apparatuses including one or more image capturing apparatuses placed facing a first gaze point and one or more image capturing apparatuses placed facing a second gaze point different from the first gaze point, it is possible achieve both the improvement of image quality and viewpoint flexibility. An example of such an arrangement will be described in the second embodiment.

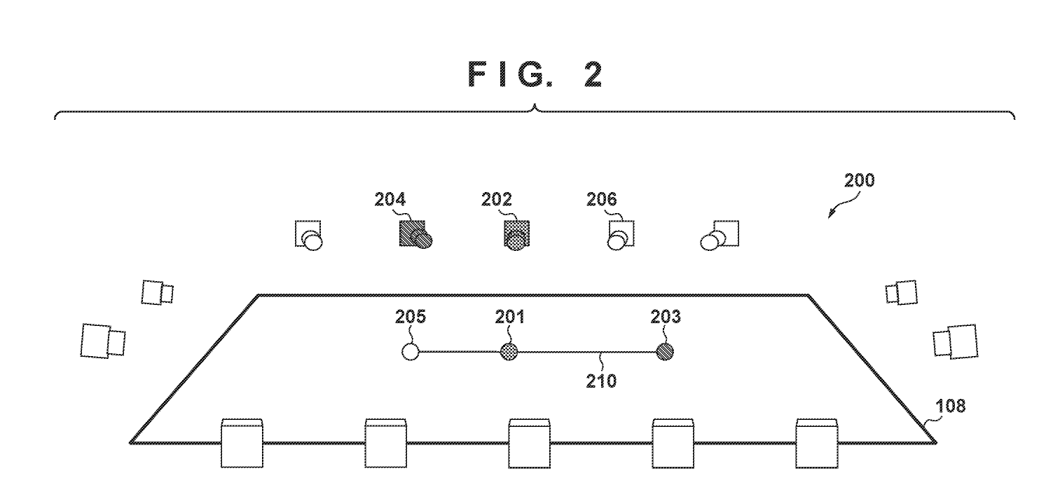

An imaging system 200 according to the second embodiment will be described with reference to FIG. 2. The imaging system 200 includes, in the same manner as FIG. 1, a plurality of image capturing apparatuses 202, a plurality of image capturing apparatuses 204, and a plurality of image capturing apparatuses 206, and uses each plurality of image capturing apparatuses to obtain a plurality of captured images to generate a free-viewpoint image. Points different from the first embodiment will be described hereinafter.

The imaging system 200 includes the first group of the image capturing apparatuses 202 including one or more image capturing apparatuses placed facing a first gaze point 201 and the second group of image capturing apparatuses 204 placed facing a second gaze point 203 which is different from the first gaze point 201. The imaging system 200 further includes the third group of image capturing apparatuses 206 placed facing a third gaze point 205 which is different from the first gaze point 201 and the second gaze point 203. The first gaze point 201, the second gaze point 203, and the third gaze point 205 are present on a line segment 210 arranged on a space. In the example of FIG. 2, the first gaze point 201, the second gaze point 203, and the third gaze point 205 are present on the line segment 210 arranged on a field 108.

According to such an arrangement, compared to a case in which the gaze point of each image capturing apparatus is set in the center of the field 108 as in the case of the conventional technique, an area in which an object can be captured by a predetermined number or more of image capturing apparatuses can be extended along the line segment. Hence, the viewpoint flexibility can be improved. Particularly, in a case in which the object has a tendency to move in a predetermined direction, the line segment can be set in accordance with this predetermined direction to maintain the viewpoint flexibility even when the object moves.

The first group of image capturing apparatuses 202, the second group of image capturing apparatuses 204, and the third group of image capturing apparatuses 206 can be arranged so that an object present on each point on the line segment 210 can be seen from two or more groups of cameras. In FIG. 2, the gaze point 201 is present on a line segment connecting the gaze points 203 and 205. In this case, the respective image capturing apparatuses can be arranged so that each image capturing apparatus 202 faces the gaze point 201, each image capturing apparatus 204 faces the gaze point 203, and each image capturing apparatus 206 faces the gaze point 205. Here, the image capturing apparatus 204, that is close to the gaze point 205 which is at one end of the line segment, is placed facing the gaze point 203 which is at the other end of the line segment. Also, the image capturing apparatus 206, that is close to the gaze point 203 which is at one end of the line segment, is placed facing the gaze point 205 which is at the other end of the line segment. In this manner, it is possible to capture each object by a plurality of image capturing apparatuses in a wider area by placing each image capturing apparatus to face a gaze point which is further away from the self-apparatus. Hence, the viewpoint flexibility can be improved.

Although FIG. 2 shows a case in which one line segment 210 is arranged, two or more line segments can be set on the space. For example, by arranging a new line segment which is perpendicular to the line segment 210 and placing each image capturing apparatus so as to face a corresponding gaze point on the new line segment, it becomes possible to generate a reconstruction image of each object in a wider range of the field 108.

Additionally, in FIG. 1, the gaze point of each image capturing apparatus forming the first group of image capturing apparatuses 102 can be shifted. For example, the first group of image capturing apparatuses 102 may include one or more image capturing apparatuses placed facing the first gaze point 101, one or more image capturing apparatuses placed facing one end of a line segment which includes the first gaze point 101, and one or more image capturing apparatuses placed facing the other end of this line segment. The second group of image capturing apparatuses 104 can also be arranged in the same manner.

### MODIFICATION OF FIRST AND SECOND EMBODIMENTS

In the first and second embodiments, the focal lengths (field angles) of the respective image capturing apparatuses can be the same. On the other hand, it is possible to maintain the image quality of a reconstruction image regardless of the position of the virtual viewpoint by changing the focal length (field angle) of each image capturing apparatus.

For example, in the example of FIG. 1, consider a case in which a reconstruction image of an object present in the gaze point 101 is to be generated. If the virtual viewpoint is present on the left side (the side of an image capturing apparatus 102b), each captured image obtained by the image capturing apparatus 102b (and an image capturing apparatus present on the left side of the object) will largely contribute to the reconstruction image. On the other hand, if the virtual viewpoint is present on the right side (the side of the image capturing apparatus 102a), each captured image obtained by the image capturing apparatus 102a (and an image capturing apparatus present on the right side of the object) will largely contribute to the reconstruction image. Here the distance between the object and the image capturing apparatus 102a is longer than the distance between the object and the image capturing apparatus 102b. Accordingly, if the field angles of the respective image capturing apparatuses 102a and 102b are the same, the object becomes smaller in the captured image obtained by the image capturing apparatus 102a in comparison to that in the captured image obtained by the image capturing apparatus 102b. Hence, the image quality of the object may change depending on the position of the virtual viewpoint.

In one embodiment, the focal length (field angle) of each image capturing apparatus can be changed in accordance with the distance between the gaze point and the image capturing apparatus. For example, the longer the distance between the image capturing apparatus and the gaze point, the image capturing apparatus can be set to have a longer focal length (a narrower field angle). According to the example of FIG. 1, the first group of image capturing apparatuses 102 includes the fourth image capturing apparatus 102a and the fifth image capturing apparatus 102b that have different field angles from each other. In addition, compared to the fourth image capturing apparatus 102a, the fifth image capturing apparatus 102b has a wider field angle and is closer to the first gaze point 101.

Although the setting method of a focal length (field angle) is not limited to a specific method, the focal length can be set so that an object present near the gaze point is captured in almost the same size on the captured images obtained by the respective image capturing apparatuses. For example, the focal length of each image capturing apparatus can be determined in accordance with the following equation.

(focal length of image capturing apparatus A)=(focal length of image capturing apparatus B)×(distance between image capturing apparatus A and its corresponding gaze point)/(distance between image capturing apparatus B and its corresponding gaze point)

This method is applicable to the example of FIG. 2. That is, the focal lengths (field angles) of the respective image capturing apparatuses 204 and 206 can be determined in accordance with the distance between each image capturing apparatus 204 and its corresponding gaze point 203 and the distance of each image capturing apparatus 206 and its corresponding gaze point 205.

### THIRD EMBODIMENT

The first and second embodiments described an arrangement that allowed the gaze points of respective image capturing apparatuses to be dispersed. The third embodiment will describe an arrangement that changes the field angle of each image capturing apparatus. An imaging system 300 according to the third embodiment includes, as in the same manner as in the first embodiment, a plurality of image capturing apparatuses 302 and a plurality of image capturing apparatuses 304, and uses the respective image capturing apparatuses to obtain a plurality of captured images to generate a free-viewpoint image. Points different from the first embodiment will be described hereinafter.

The imaging system 300 according to the third embodiment includes the first group of image capturing apparatuses 302 including one or more image capturing apparatuses and a second group of image capturing apparatuses 304 including one or more image capturing apparatuses each having a wider field angle than that of the first group of image capturing apparatuses 302. According to such an arrangement, the image quality can be improved for an area covered by the first group of image capturing apparatuses 302. In addition, since a wide area of the space can be covered by the second group of image capturing apparatuses 304, it is possible to improve the viewpoint flexibility.

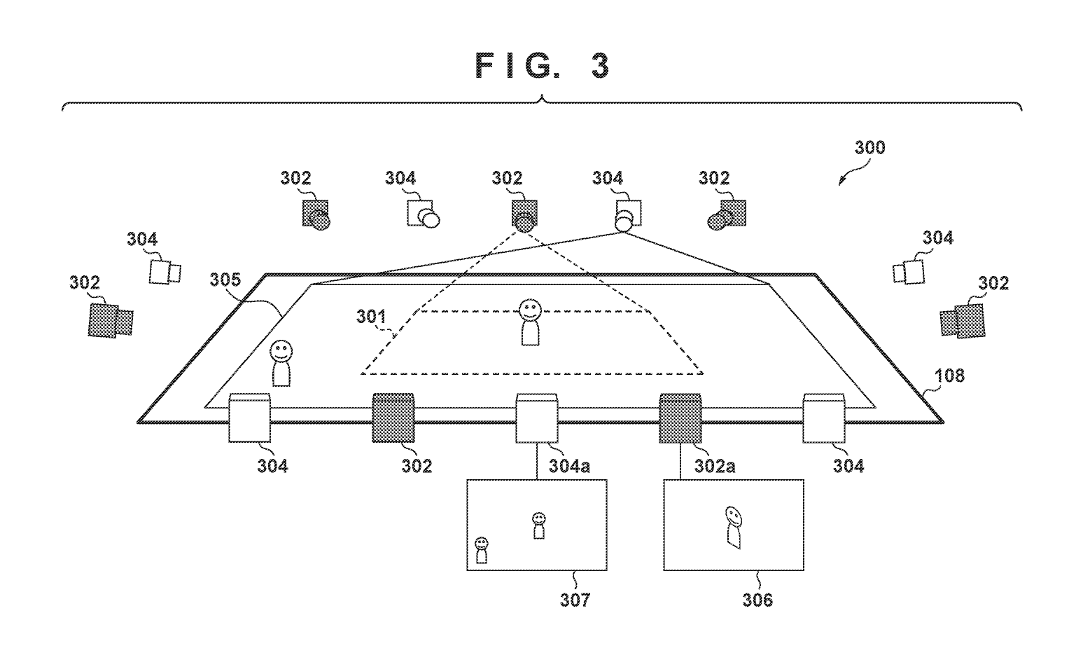

An example of such an arrangement will be described with reference to FIG. 3. The first group of image capturing apparatuses 302 is arranged so that a first area 301 on a field 108 will be in the field of view of each apparatus. In other words, the first area 301 is a commonly viewed area of the first group of image capturing apparatuses 302. Also, the second group of image capturing apparatuses 304 is arranged so that a second area 305 on the field 108 will be in the field of view of each apparatus. In other words, the second area 305 is a commonly viewed area of the second group of image capturing apparatuses 304. Here, the first area 301 is included in the second area 305. In FIG. 3, an image 306 captured by an image capturing apparatus 302a included in the first group of image capturing apparatuses 302 and an image 307 captured by an image capturing apparatus 304a included in the second group of image capturing apparatuses 304 are shown.

According to such an arrangement, the first group of image capturing apparatuses 302 can capture an object on the first area 301 from various directions. Additionally, since the field angles of the image capturing apparatuses 302 of the first group can be narrowed, the image quality can be improved. On the other hand, although each image capturing apparatus of the second group of image capturing apparatuses 304 may have a limited image quality due to having a wide field angle, the viewpoint flexibility can be ensured since the second group of image capturing apparatuses 304 can capture an object on the second area 305 from various directions. In this manner, according to the arrangement of FIG. 3, the viewpoint flexibility and image quality with good overall balance can be obtained.

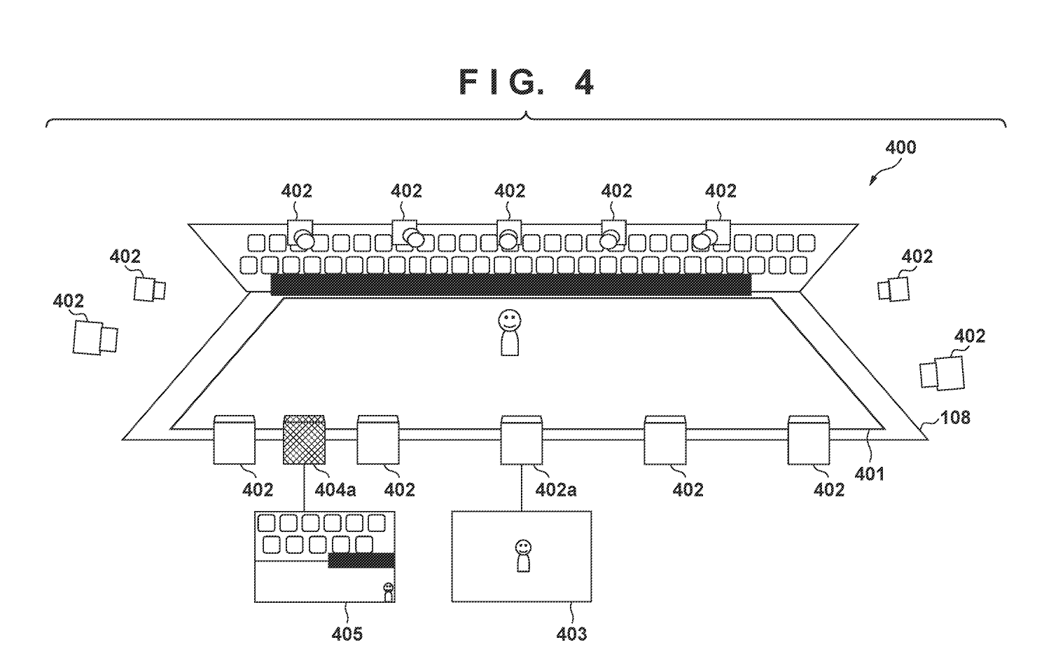

Another arrangement example will be described with reference to FIG. 4. A first group of image capturing apparatuses 402 is placed so that a first area 401 on the field 108 is in the field of view of each apparatus. In other words, the first area 401 is a commonly viewed area of the first group of image capturing apparatuses 402. A second group of image capturing apparatuses including image capturing apparatuses each having a wider field angle than those of the first group of image capturing apparatuses 402. Although FIG. 4 shows the second group of image capturing apparatuses including one image capturing apparatus 404a, the second group of image capturing apparatuses may include two or more image capturing apparatuses.

The second group of image capturing apparatuses can be placed facing a gaze point arranged outside the field 108. For example, in FIG. 4, the second group of image capturing apparatuses has been placed facing the stand. FIG. 4 shows, as an example, an image 403 captured by one image capturing apparatus 402a of the first group of image capturing apparatuses 402 and an image 405 captured by one image capturing apparatus 404a of the second group of image capturing apparatuses. The second group of image capturing apparatuses can be placed so that it can capture an object area other than the first area 401. For example, the image capturing apparatuses of the second group can be placed and have their respective field angles adjusted so as to cover the entire scene (the entire stand). According to such an arrangement, a reconstruction image can be obtained for an object outside the field 108 such as an object in the stand.

In this manner, the arrangement of FIG. 4 can also obtain viewpoint flexibility and image quality with good overall balance by combining a group of image capturing apparatuses in which each apparatus has a narrower field angle and a group of image capturing apparatuses in which each apparatus has a wider field angle.

### FOURTH EMBODIMENT

The first to third embodiments each described an example of an imaging system for generating a free-viewpoint image. This embodiment will describe an image processing apparatus and a processing method thereof that can generate a free-viewpoint image by using a captured image obtained by an imaging system. This embodiment will describe a method of generating a reconstruction image in which one object is mainly present and moving in a space. It is also possible, however, to generate a reconstruction image in which two or more objects are present by the same method. In addition, the object may be an object that moves, such as a person, or may be an object that does not move, such as the floor or the background.

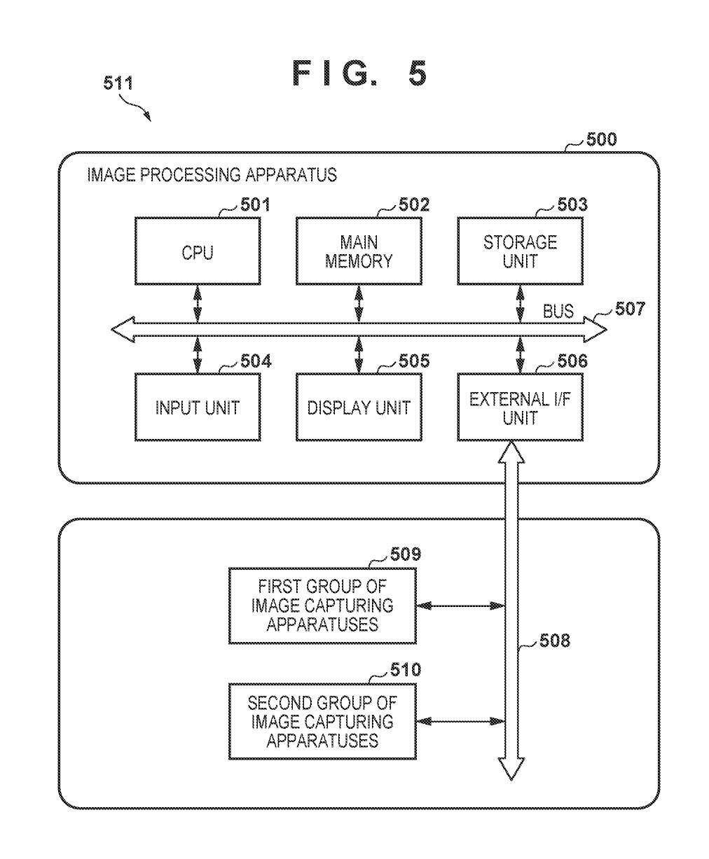

The image processing apparatus according to this embodiment can be, for example, a computer including a processor and a memory. FIG. 5 shows an example of the hardware arrangement of an image processing apparatus 500 according to this embodiment. The image processing apparatus 500 includes a CPU 501, a main memory 502, a storage unit 503, an input unit 504, a display unit 505, an external I/F unit 506, and a bus 507.

The CPU 501 executes operation processing and various kinds of programs. The main memory 502 provides, to the CPU 501, a work area, data, and programs necessary for processing. The storage unit 503 is, for example, a hard disk or a silicon disk and stores various kinds of programs or data. The input unit 504 is, for example, a keyboard, a mouse, an electronic pen, or a touch panel and accepts an operation input from a user. The display unit 505 is for example, a display and displays a GUI and the like in accordance with the control of the CPU 501. The external I/F unit 506 is an interface to an external apparatus. In this embodiment, the external I/F unit 506 is connected to a group of image capturing apparatuses via a LAN 508 and exchanges video data and control signal data with the group of image capturing apparatuses. The bus 507 is connected to each unit described above and transfers data.

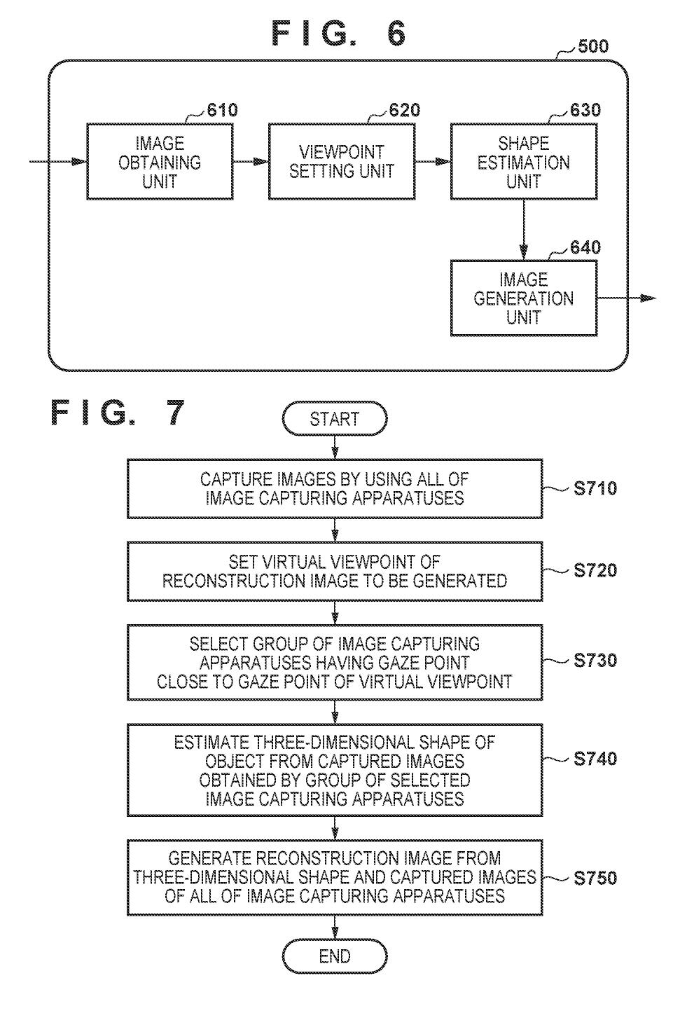

The operations of respective units to be described below, as that shown in FIG. 6, can be implemented as follows. That is, a program corresponding to the operation of each unit stored in a computer-readable storage medium such as the storage unit 503 or the like is loaded into the main memory 502. Then, the operation of each unit to be described below can be implemented by the CPU 501 operating in accordance with this program. Some or all of the operations of the respective units to be described below may be implemented by dedicated hardware such as ASIC or the like, as a matter of course.

The image processing apparatus 500 is connected to a first group of image capturing apparatuses 509 and a second group of image capturing apparatuses 510 and forms an imaging system 511. The first group of image capturing apparatuses 509 and the second group of image capturing apparatuses 510 start and stop imaging, change settings (such as the shutter speed or the aperture), and transfer imaging data in accordance with the control signal from the image processing apparatus 500. The first group of image capturing apparatuses 509 and the second group of image capturing apparatuses 510 can be arranged around a space in accordance with, for example, the first to third embodiments.

FIG. 6 shows the functional arrangement included in the image processing apparatus 500. As shown in FIG. 6, the image processing apparatus 500 includes an image obtaining unit 610, a viewpoint setting unit 620, a shape estimation unit 630, and an image generation unit 640.

The image obtaining unit 610 obtains a plurality of captured images that have been obtained by the plurality of image capturing apparatuses 509 and the plurality of image capturing apparatuses 510 by capturing an object. The image obtaining unit 610 can cause the plurality of image capturing apparatuses 509 and the plurality of image capturing apparatuses 510 to simultaneously capture the object and transmit the obtained captured images to the image obtaining unit 610 by controlling the plurality of image capturing apparatuses 509 and the plurality of image capturing apparatuses 510 via the LAN 508. A moving image can also be obtained by causing the plurality of image capturing apparatuses 509 and the plurality of image capturing apparatuses 510 to continuously capture images. In this case, the image processing apparatus 500 can generate a moving image formed from reconstruction images by performing processing by using the captured image of each frame.

The viewpoint setting unit 620 performs setting of a virtual viewpoint of a reconstruction image. More specifically, the viewpoint setting unit 620 can set the three-dimensional position and the orientation (or the optical-axis direction) of the virtual viewpoint. The viewpoint setting unit 620 can further set the field angle and the resolution of the virtual viewpoint. The viewpoint setting unit 620 can perform the setting of the virtual viewpoint based on a user instruction input via the input unit 504.

The shape estimation unit 630 estimates the shape of the object based on each captured image obtained by the image obtaining unit 610. More specifically, the shape estimation unit 630 cuts out a desired object area from each captured image and estimates the three-dimensional position and shape of the object based on the obtained image. In this embodiment, the positional relationship of the plurality of image capturing apparatuses 509 and the plurality of image capturing apparatuses 510 is already known and has been stored in the storage unit 503 in advance. The method of estimating the three-dimensional position and shape of the object based on each captured image of the object obtained by such plurality of image capturing apparatuses 509 and such plurality of image capturing apparatuses 510 is well known, and an arbitrary method can be adopted. For example, a three-dimensional model of the object can be generated by using a stereo matching method or a volume intersection method disclosed in Japanese Patent Laid-Open No. 2010-020487.

The shape estimation unit 630 can estimate the shape of the object by using all of the captured images obtained by the plurality of image capturing apparatuses 509 and the plurality of image capturing apparatuses 510. On the other hand, the shape estimation unit 630 can also estimate the shape of the object by using images captured by a group of selected image capturing apparatuses that have been selected from the plurality of image capturing apparatuses 509 and 510. In this case, the shape estimation unit 630 selects, from the plurality of image capturing apparatuses 509 and the plurality of image capturing apparatuses 510, a group of selected image capturing apparatuses that is to be used for estimating the shape of the object. Then the shape estimation unit 630 estimates the shape of the object by using each captured image obtained by the group of selected image capturing apparatuses. In this embodiment, a captured image that has been obtained by the group of unselected image capturing apparatuses is not used to estimate the shape of the object. Note that as it is apparent from the fact that the image generation unit 640 (to be described later) estimates the color of the object by using each captured image obtained from a group of unselected image capturing apparatuses, there is a possibility that a captured image which includes the object may not be used to estimate the shape of the object.

In this embodiment, the shape estimation unit 630 selects the group of selected image capturing apparatuses in accordance with the arrangement of the virtual viewpoint. For example, the shape estimation unit 630 can select a group of selected image capturing apparatuses based on the relationship between the gaze point of the virtual viewpoint and the gaze point of the image capturing apparatuses. Here, the shape estimation unit 630 can select, as the group of selected image capturing apparatuses, a group of image capturing apparatuses that has a gaze point closer to the gaze point of the virtual viewpoint. For example, a case in which a first group of image capturing apparatuses 102 which is placed facing a first gaze point 101 and a second group of image capturing apparatuses 104 which is placed facing a second gaze point 103 are present will be described in accordance with FIG. 1. If the gaze point of the virtual viewpoint is closer to the second gaze point 103 than the first gaze point 101, the shape estimation unit 630 selects the second group of image capturing apparatuses 104 as the group of selected image capturing apparatuses. If the gaze point of the virtual viewpoint is closer to the first gaze point 101 than the second gaze point 103, the shape estimation unit 630 selects the first group of image capturing apparatuses 102 as the group of selected image capturing apparatuses. In this manner, the shape estimation unit 630 can switch the group of selected image capturing apparatuses between the first group of image capturing apparatuses 102 placed facing a first gaze point 101 and the second group of image capturing apparatuses 104 placed facing a second gaze point 103. This switching is performed depending on whether the gaze point of the virtual viewpoint is closer to the first gaze point 101 or the second gaze point 103.

A case in which there are image capturing apparatuses placed to face different gaze points from each other will be described with in accordance with FIG. 2. In this case, the shape estimation unit 630 can select, as the group of selected image capturing apparatuses, a group of image capturing apparatuses that has a gaze point which is within a predetermined rage from the gaze point of the virtual viewpoint. In addition, the shape estimation unit 630 can select, as the group of selected image capturing apparatuses, a predetermined number of groups of image capturing apparatuses that has a gaze point which is closer to the gaze point of the virtual viewpoint.

As another example, the shape estimation unit 630 can select the group of selected image capturing apparatuses based on the relationship between the gaze point of the virtual viewpoint and the commonly viewed area of the group of image capturing apparatuses. For example, the shape estimation unit 630 can select a group of image capturing apparatuses as the group of selected image capturing apparatuses if the gaze point of the virtual viewpoint is included in the commonly viewed area of this group of the image capturing apparatuses. A case in which there are a first group of image capturing apparatuses 302 which has a commonly viewed area 301 and a second group of image capturing apparatuses 304 which has a commonly viewed area 305 will be described as an example in accordance with FIG. 3. If the gaze point of the virtual viewpoint is included in the commonly viewed area 301, the shape estimation unit 630 selects the first group of image capturing apparatuses 302 as the group of selected image capturing apparatuses. If the gaze point of the virtual viewpoint is not included in the commonly viewed area 301 but included in the commonly viewed area 305, the shape estimation unit 630 selects the second group of image capturing apparatuses 304 as the group of selected image capturing apparatuses. Here, a priority order can be set for the respective groups of image capturing apparatuses, and the first group of image capturing apparatuses 302 is preferentially selected over the second group of image capturing apparatuses 304 in this example. In this case, the shape estimation unit 630 preferentially selects the first group of image capturing apparatuses 302 in which each apparatus has a narrower field angle. In this manner, the shape estimation unit 630 can switch whether to select, as the group of selected image capturing apparatuses, the first group of image capturing apparatuses 302 which is placed so that the first area 301 is in the field of view of each apparatus, depending on whether the gaze point of the virtual viewpoint is included in the commonly viewed area 301.

In this manner, by using captured images obtained by the group of selected image capturing apparatuses to estimate the shape of an object, the number of captured images used for estimation processing can be reduced. Hence, the estimation processing load can be reduced. On the other hand, since it is highly possible that an object to be included in a reconstruction image will be included in a captured image obtained by the group of selected image capturing apparatuses which was selected in accordance with the arrangement of the virtual viewpoint, the three-dimensional shape of the object can be obtained with high accuracy, and the high image quality can be maintained. Here, although a method of selecting a group of image capturing apparatuses based on the gaze point of the virtual viewpoint has been described, the present invention is not limited to this. For example, the shape estimation unit 630 may select a group of image capturing apparatuses whose gaze point is present in the field-of-view area of the virtual viewpoint or select a group of image capturing apparatuses that has a commonly viewed area which overlaps with the field-of-view area of the virtual viewpoint.

In addition, although the method of selecting a group of image capturing apparatuses based on the arrangement of the virtual viewpoint has been described here, the present invention is not limited to this method. For example, the group of image capturing apparatuses can be selected based on the relationship between the position of the object and the commonly viewed area or the gaze point of the group of image capturing apparatuses. As one example, the shape of an object that is close to the gaze point 101 or the commonly viewed area 105 can be estimated by using the captured images obtained by the first group of image capturing apparatuses 102. Also, the shape of an object close to the second gaze point 103 or the commonly viewed area 106 can be estimated by using the captured images obtained by the second group of image capturing apparatuses 104.

The image generation unit 640 estimates the color of an object by using both the captured images obtained by the group of selected image capturing apparatuses and the captured images obtained by the group of unselected image capturing apparatuses that was not selected as the group of selected image capturing apparatuses. Next, the image generation unit 640 generates a reconstruction image from the virtual viewpoint based on the estimated shape and color of the object. In a case in which the gaze point of the virtual viewpoint is present near the first gaze point 101 in the example of FIG. 1, the shape estimation unit 630 selects the first group of image capturing apparatuses 102 and does not select the second group of image capturing apparatuses 104. On the other hand, since an image capturing apparatus 104a is close to the gaze point of the virtual viewpoint, it is highly possible that the object to be included in the reconstruction image will be included in a large shape in a captured image obtained by the image capturing apparatus 104a. Hence, in this embodiment, when the color of the object is estimated, the quality of the reconstruction image is improved by using also each captured image obtained by the group of unselected image capturing apparatuses.

The method of estimating the color of an object from each captured image and the shape of the object is well known, and the image generation unit 640 can use an arbitrary method to generate a reconstruction image. For example, since the three-dimensional position and shape of the object have been obtained by the shape estimation unit 630, and by using the position, the orientation, the field angle, and the resolution information of each of the image capturing apparatuses 509 and 510, it is possible to specify each pixel on a captured image corresponding to each position on the object. Based on the pixel color information specified in this manner, the color of each position on the object can be specified.

As one example, a method of generating a reconstruction image by using a distance map will be briefly described. First, the image generation unit 640 generates a distance map of an object seen from a virtual viewpoint by using the position and shape information of the object and the position and orientation information of the virtual viewpoint. Next, the image generation unit 640 specifies, for each pixel of the reconstruction image, the position of the object in this pixel by referring to the distance map and obtains the color information of the object in this pixel by further referring to a corresponding captured image. The image generation unit 640 can generate a reconstruction image in this manner.

As shown in FIG. 4, in a case in which a group of image capturing apparatuses 404 is used to capture an image of an area outside the field 108 such as the stand or the like, the following processing can be performed. That is, for an object that is present in the field 108, the image generation unit 640 can determine the color of the object by using each captured image obtained by a group of image capturing apparatuses 402. On the other hand, for an object that is present outside the field 108, the image generation unit 640 can determine the color of the object by using each captured image obtained by the group of image capturing apparatuses 404. As another method, the image generation unit 640 can also determine the color of an object by weighted combination. In this case, a larger weight can be given to a captured image obtained by the group of image capturing apparatuses 402 for an object that is present in the field 108, and a larger weight can be given to a captured image obtained by the group of image capturing apparatuses 404 for an object that is present outside the field 108.

The processing procedure of an image processing method according to this embodiment will be described next with reference to FIG. 7. In step S710, the plurality of image capturing apparatuses 509 and the plurality of image capturing apparatuses 510 capture images of an object and the image obtaining unit 610 obtains the captured images. In step S720, the viewpoint setting unit 620 sets the virtual viewpoint of a reconstruction image. In step S730, the shape estimation unit 630 selects image capturing apparatuses to be used to estimate the shape of the object. In step S740, the shape estimation unit 630 uses each captured image obtained by the selected image capturing apparatuses to estimate the shape of the object. As previously described, instead of performing step S730, the shape of the object may be estimated by using each captured image obtained by all of the image capturing apparatuses in step S740. In step S750, the image generation unit 640 generates the reconstruction image based on the obtained object shape and the captured images obtained by the plurality of image capturing apparatuses 509 and the plurality of image capturing apparatuses 510.

### FIFTH EMBODIMENT

The first to third embodiments each described a case in which the plurality of image capturing apparatuses have a fixed position and orientation. In this embodiment, the orientation or the field angle of at least one image capturing apparatus is controlled. Although the arrangement of an imaging system according to this embodiment is the same as the first to third embodiments, the orientation or the field angle of at least one image capturing apparatus is arranged to be controllable, and a control apparatus for controlling the orientation or the field angle of the at least one image capturing apparatus is also included in the arrangement. As the control apparatus, for example, an image processing apparatus 500 shown in FIG. 5 can be used. In this embodiment, the gaze point of at least one image capturing apparatus can be changed by placing the image capturing apparatus on a motorized tripod and controlling the orientation of the motorized tripod by a CPU 501 via a LAN 508. The CPU 501 can also control the field angle of the image capturing apparatus via the LAN 508. Hence, the control apparatus can control the orientation or the field angle of the image capturing apparatus in a similar manner to the arrangement of the imaging system shown in the first to third embodiments.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-194777, filed Sep. 30, 2016, which is hereby incorporated by reference herein in its entirety.

What is claimed is:

1. An imaging system comprising a plurality of image capturing apparatuses, wherein the plurality of image capturing apparatuses are configured to obtain captured images to generate a free-viewpoint image, and wherein the plurality of image capturing apparatuses include a first group of one or more image capturing apparatuses facing a first gaze point and a second group of one or more image capturing apparatuses facing a second gaze point different from the first gaze point.

2. The system according to claim 1, wherein the plurality of image capturing apparatuses surround a field.

3. The system according to claim 2, wherein a first area on the field is in the field of view of each of the first group of image capturing apparatuses,
a second area on the field is in the field of view of each of the second group of image capturing apparatuses, and
a barycenter of the first area is not included in the second area.

4. The system according to claim 3, wherein at least one image capturing apparatus of the first group of image capturing apparatuses is placed closer to the second area than the first area.

5. The system according to claim 1, wherein the first group of image capturing apparatuses includes a fourth image capturing apparatus and a fifth image capturing apparatus that have different field angles from each other, and the fifth image capturing apparatus has a wider field angle and is closer to the first gaze point compared to the fourth image capturing apparatus.

6. The system according to claim 2, wherein the plurality of image capturing apparatuses include a third group of one or more image capturing apparatuses placed facing a third gaze point different from the first gaze point and the second gaze point, and
the first gaze point, the second gaze point, and the third gaze point are on a line segment on the field.

7. An imaging system comprising a plurality of image capturing apparatuses, wherein each of the plurality of image capturing apparatuses are configured to obtain a captured image to generate a free-viewpoint image, and wherein the plurality of image capturing apparatuses include a first group of one or more image capturing apparatuses and a second group of one or more image capturing apparatuses having a wider field angle than the first group of image capturing apparatuses.

8. The system according to claim 7, wherein the plurality of image capturing apparatuses surround a field,
a first area on the field is in the field of view of each of the first group of image capturing apparatuses,
a second area on the field is in the field of view of each of the second group of image capturing apparatuses, and
the first area is included in the second area.

9. The system according to claim 1, wherein at least one of an orientation or a field angle of at least one of the plurality of image capturing apparatuses can be controlled, and
the system further comprises
a control apparatus configured to control the at least one of the orientation or the field angle of the at least one of the plurality of the image capturing apparatus.

10. An image processing apparatus comprising:
an obtaining unit configured to obtain a captured image obtained by each of a plurality of image capturing apparatuses by capturing an object;
a setting unit configured to set a virtual viewpoint of a reconstruction image;
an estimation unit configured to estimate a shape of the object by selecting, from the plurality of image capturing apparatuses, a group of selected image capturing apparatuses to be used for estimating the shape of the object and using each captured image obtained by the group of selected image capturing apparatuses; and
a generation unit configured to estimate a color of the object by using both the captured image obtained by the group of selected image capturing apparatuses and a captured image obtained by a group of unselected image capturing apparatuses which was not selected as the group of selected image capturing apparatuses and generate the reconstruction image from the virtual viewpoint based on the estimated shape and color of the object.

11. The apparatus according to claim 10, wherein the estimation unit is further configured to select the group of selected image capturing apparatuses in accordance with a position of the virtual viewpoint.

12. The apparatus according to claim 11, wherein the plurality of image capturing apparatuses include a group of image capturing apparatuses facing a first gaze point and a group of image capturing apparatuses facing a second gaze point, and
the estimation unit switches the group of selected image capturing apparatuses between the group of image capturing apparatuses facing the first gaze point and the group of image capturing apparatuses facing the second gaze point, in accordance with whether a gaze point of the virtual viewpoint is closer to the first gaze point or the second gaze point.

13. The apparatus according to claim 11, wherein the plurality of image capturing apparatuses include a group of image capturing apparatuses each having a field of view including a first area on a field, and
the estimation unit switches whether to select, as the group of selected image capturing apparatuses, the group of image capturing apparatuses each having a field of view including the first area, in accordance with whether a gaze point of the virtual viewpoint is included in the first area.

14. An image processing method comprising:
obtaining a captured image obtained by each of a plurality of image capturing apparatuses by capturing an object;
setting a virtual viewpoint of a reconstruction image;
estimating a shape of the object by selecting, from the plurality of image capturing apparatuses, a group of selected image capturing apparatuses to be used for estimating the shape of the object and using each captured image obtained by the group of selected image capturing apparatuses;
estimating a color of the object by using both the captured image obtained by the group of selected image capturing apparatuses and a captured image obtained by a group of unselected image capturing apparatuses which was not selected as the group of selected image capturing apparatuses; and
generating the reconstruction image from the virtual viewpoint based on the estimated shape and color of the object.

15. A non-transitory computer-readable medium storing a program for causing a computer to:
obtain a captured image obtained by each of a plurality of image capturing apparatuses by capturing an object;
set a virtual viewpoint of a reconstruction image;
estimate a shape of the object by selecting, from the plurality of image capturing apparatuses, a group of selected image capturing apparatuses to be used for estimating the shape of the object and using each captured image obtained by the group of selected image capturing apparatuses;
estimate a color of the object by using both the captured image obtained by the group of selected image capturing apparatuses and a captured image obtained by a group of unselected image capturing apparatuses which was not selected as the group of selected image capturing apparatuses; and
generate the reconstruction image from the virtual viewpoint based on the estimated shape and color of the object.
